(19) United States
(12) Patent Application Publication
(10) Pub. No.: US 2009/0224637 A1
(43) Pub. Date: Sep. 10, 2009

(54) Door assembly and clothes treating machine having the same

(75) Inventors: Jung Wook Moon, Changwon-si (KR); Dae Yun Park, Changwon-si (KR); Sog Kie Hong, Changwon-si (KR); Jong Seok Kim, Changwon-si (KR); Seung Gyu Ryu, Changwon-si (KR); Hye Yong Park, Changwon-si (KR); Chang Gyu Choi, Changwon-si (KR); Dong Won Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/219,945

(22) Filed: Jul. 30, 2008

(30) Foreign Application Priority Data
Mar. 8, 2008 (KR) 10-2007-0078286

(51) Int. Cl. E06B 3/08

(52) U.S. Cl. 312/109

(57) ABSTRACT

A trim kit type door assembly for an electronic product is disclosed. In the door assembly including door plates and left and right side caps coupled to both sides of the door plates, an opening/closing door handle is integrally formed with one of the left and right side caps, achieving a reduction in manufacturing costs. Also, when the door handle of the side cap takes the form of a recessed portion integrally defined in the side cap so as not to protrude outward from the side cap, the resulting door assembly achieves an exterior appearance satisfying the aesthetic demands of consumers.

This application claims the benefit of the Korean Patent Application No. 10-2007-0078286, filed on, Aug. 3, 2007, which is hereby incorporated by reference as if fully set forth herein.

### BACKGROUND OF THE INVENTION

1. Field of the Invention

The present invention relates to a door assembly and a clothes treating machine having the door assembly.

2. Discussion of the Related Art

Recently produced electronic products have a trend to improve the exterior appearance of a portion visible to consumers, according to aesthetic demands of consumers, in addition to improving the performance thereof. To deal with this trend, a front portion of electronic products have been frequently designed to a called “trim kit” type. Trim kit type means that a panel located at the portion of the electronic products exposed to the consumer's view is exchangeable, and the exchangeable panel can be designed to have various patterns.

For example, in the case of electronic products, such as refrigerators, cabinet type clothes treating machines, air conditioners, etc., they are internally defined with receiving space(s) and opening/closing door(s) are provided at a front side of the electronic products for various purposes, for example, easy repair/maintenance of the interior of the electronic products.

Moreover, when the door of the electronic products is designed to a trim kit type, an outermost front panel of the door exposed to the consumer's view can be made of a transparent glass or plastic and therefore, an additional panel having various patterns and colors can be inserted into the outermost front panel.

That is, most conventional electronic products have been designed to have an integrally-formed plastic or metal housing and therefore, providing a product surface with patterns or colors to satisfy the aesthetic demands of consumers is difficult. Only changing a color of the door to a specific color or providing a front surface of the door with a simple pattern, etc. is possible. However, this could not satisfy all of the consumer's increasing aesthetic demands.

Accordingly, if an outermost front panel of the door is exchangeable or a panel having a desired pattern or color can be inserted in a transparent front panel, this means that a product selection can be expanded to provide consumers with favorite colors and patterns. Also, in the case of electronic products in which an outer structure is constructed by an integrally-formed plastic or metal plate, providing a product surface with an external appearance to satisfy the consumer demand has a limit and therefore, a front portion or door portion of the electronic products can be manufactured to a trim kit type.

However, manufacturing a door of the electronic products, such as refrigerators or cabinet type clothes treating machines, to a trim kit type has the following problems. For example, in the case of refrigerators or cabinet type clothes treating machines, a door occupies the entire front portion of the electronic products, and a door handle must be provided for convenience of use because the door must be frequently opened or closed.

FIG. 1 is a perspective view illustrating a conventional refrigerator provided with a general door 100′. In the case of the conventional refrigerator, a door handle 22b′ is generally mounted at a front surface or a side surface of a metal door.

Even in the case of a trim kit type door, a door handle must be additionally provided thereto. However, when mounting a handle to a trim kit type door, it is difficult to aesthetically harmonize the handle with an outermost front panel of the door having various patterns and colors. Further, the outermost front panel of the trim kit type door is generally made of glass or synthetic resins and therefore, directly mounting the door handle to the outermost front panel may cause deterioration of durability, etc.

In the case of a cabinet type clothes treating machine which has a thin door thickness and is generally installed at the same place as, for example, general furniture, it is unnecessary to design a door handle for the clothes treating machine in the same manner as that of a general refrigerator, and aesthetic harmonization between the door handle and the surrounding furniture must be contemplated.

### SUMMARY OF THE INVENTION

Accordingly, the present invention is directed to a door assembly and a clothes treating machine having the same that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a door assembly comprises: one or more door plates; left and right side caps, into which both sides of the door plates are fixedly inserted, respectively; and a handle integrally formed with one of the left and right side caps.

In this case, the door plates may include: a front plate to be exposed forward; and a rear plate defining a rear door surface.

The door assembly may further comprise an insulator provided between the front plate and the rear plate.

The front plate may be made of transparent glass or synthetic resins, and an ornament may be inserted between the front plate and the rear plate.

The ornament may be attached to or coated on the front plate.

The handle may be a circular rod member integrally formed with the side cap such that it is spaced apart from an outer surface of the side cap.

The handle may be a curved plate extending in a longitudinal direction of the side cap to define a recessed portion in the side cap.

Preferably, the side cap, formed with the handle, has a constant transversal cross section throughout the longitudinal direction of the side cap.

The side cap may be made of a metal material.

In accordance with another aspect of the invention, there is provided a clothes treating machine comprising: a cabinet having an accommodating space in which clothes are received; a machine room receiving at least one of a moisture supplying device to feed moisture into the accommodating space and an air supplying device to feed hot or dry air into the accommodating space, the machine room being defined in the cabinet and separated from the accommodating space; and a door assembly to open or close the accommodating space, the door assembly including one or more door plates, left and right side caps, into which both sides of the door plates are fixedly inserted, respectively, and a handle integrally formed with one of the left and right side caps.

In this case, the door plates may include a front plate to be exposed forward, a rear plate defining a rear door surface, and an insulator provided between the front plate and the rear plate.

The handle may be a curved plate extending in a longitudinal direction of the side cap to define a recessed portion in the side cap.

The side cap, formed with the handle, may have a constant transversal cross section throughout the longitudinal direction of the side cap.

The side cap may be made of a metal material.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a conventional refrigerator;

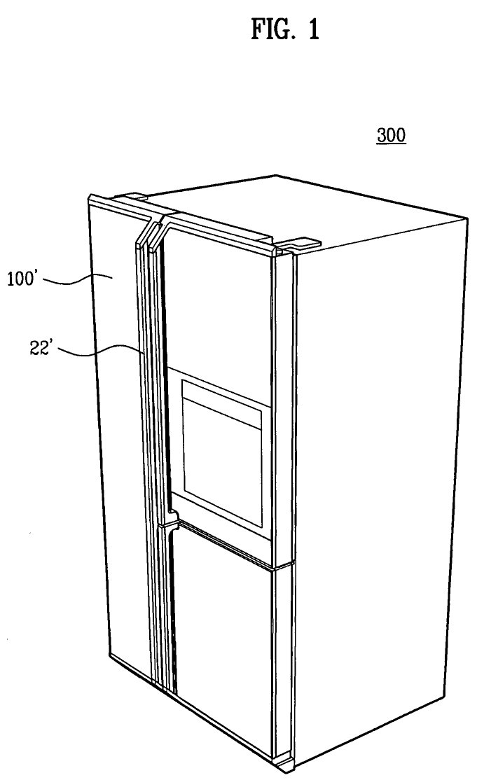

FIG. 2 is an exploded perspective view illustrating a door assembly according to an embodiment of the present invention;

FIG. 3 is an exploded perspective view illustrating a door assembly according to another embodiment of the present invention;

FIG. 4 is a perspective view illustrating a single-door type clothes treating machine according to the present invention; and

FIG. 5 is a perspective view illustrating a double-door type clothes treating machine according to the present invention.

### DETAILED DESCRIPTION OF THE INVENTION

Reference will now be made in detail to the preferred embodiments of the present invention, examples of which are illustrated in the accompanying drawings. However, the present invention is not limited to the embodiments described herein and may be embodied in other configurations. The following description of the present invention has been made for a complete understanding of the present invention and to sufficiently transfer the idea of the present invention to those skilled in the art. Wherever possible, the same reference numbers will be used throughout the drawings to refer to the same or like parts.

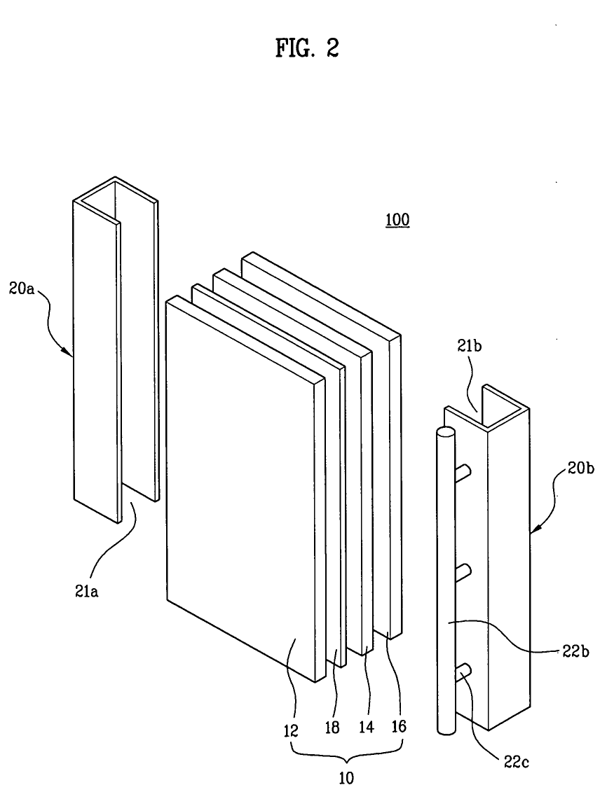

FIG. 2 is an exploded perspective view illustrating a door assembly 100 according to an embodiment of the present invention. The door assembly shown in FIG. 2 includes a plurality of door plates 10, and left and right side caps 20aand 20b used to couple the plurality of door plates 10 to one another. The side caps 20a and 20b may be formed to U-shaped elongated plate members having insertion recesses 21a and 21b, respectively, into which a stack of the plurality of door plates 10 can be inserted.

Any one of the left and right side caps 20a and 20b, into which both sides of the respective door plates 10 are fixedly inserted, is integrally provided with a handle 22b.

In the embodiment of the present invention, the handle 22b takes the form of a circular rod member, which is integrally formed with the side cap 20b such that it is spaced apart from an outer surface of the side cap 20b.

More particularly, the handle 22b in the form of the circular rod member may be embodied as an elongated pipe extending in a longitudinal direction of the side cap 20b, and may be integrally connected to the side cap 20b by means of a plurality of connecting rods 22c extending forward from the outer surface of the side cap 20b such that the handle 22b is spaced apart from the outer surface of the side cap 20b.

The handle 22b in the form of the circular rods member advantageously assures stable opening/closing of even a heavy door.

The door plates 10 include a front plate 12 to be exposed to the outside and a rear plate 16 defining a door rear surface. The door assembly 100 according to the present invention may be mounted to, for example, a clothes treating machine that will be described hereinafter. The clothes treating machine is an apparatus designed in such a manner that moisture or hot or dry air is fed into, for example, an accommodating space defined in the clothes treating machine, to remove unpleasant odors, wrinkles, or the like of clothes received in the accommodating space.

When being mounted to the clothes treating machine, accordingly, the door plates 10 may include an insulator plate 14 to allow the fed moisture (e.g. steam) or hot air (or dry air) to be effectively used for treatment of clothes. That is, in the case where the accommodating space of an electronic product has a temperature difference with the outside similar to a refrigerator for storing food at a refrigerating or freezing temperature or the clothes treating machine for treating clothes using moisture (e.g. steam) or hot air (or dry air), it is preferred that an insulator plate be provided among the door plates 10. A detailed description of the clothes treating machine will be given later.

The front plate 12 may be made of transparent glass or synthetic resins. In this case, ornaments 18 may be inserted between the front plate 12 and the rear plate 16.

When additionally inserting the ornaments, various kinds of ornaments can be used, thereby advantageously satisfying different demands of consumers.

Alternatively, instead of inserting the ornaments 18, the front plate 12, as a foremost plate of the door plates 10, may be formed to have various colors and patterns.

Note that the embodiment of the door assembly 100 shown in FIG. 2 is proposed only as one example, and the door assembly 100 can be embodied into various configurations according to the type and use purpose of an electronic product to which the door assembly 100 will be mounted.

The door plates 10 are fixedly coupled to one another by means of the left and right side caps 20a and 20b. Although the embodiment of the door assembly 100 according to the present invention as shown in FIG. 2 describes the side caps 20a and 20b provided only at both the left and right sides of the door plates 10 to couple the door plates 10 to one another, it will be clearly understood that upper and lower caps may be mounted to upper and lower ends of the door plates 10.

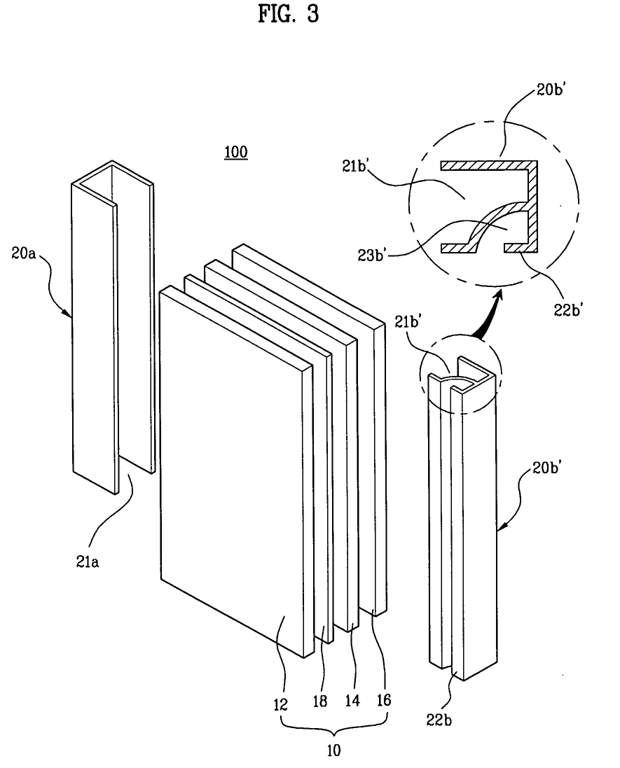

FIG. 3 is an exploded perspective view illustrating a door assembly according to another embodiment of the present invention. Similar to the previously described embodiment shown in FIG. 2, the door assembly 100 according to the present embodiment shown in FIG. 3 is configured in such a manner that a handle 22b′ is integrally formed with one of left and right side caps 20a′ and 20b′.

The handle 22b′, formed at one of the left and right side caps 20a′ and 20b′, can be variously changed in shape.

For example, when being applied to a refrigerator in which contents must be stored even at a rear surface of a door, a relatively great force must be required to open the door and therefore, it is preferred that the handle have a configuration to assure stable opening/closing of the door.

However, when being applied to the above-described clothes treating machine having a relatively light-weight door, the above-described pipe-shaped handle may be unnecessary. Furthermore, in consideration of the fact that the clothes treating machine is generally installed in a bedroom or dressing room, it is necessary to contemplate aesthetic harmonization between the clothes treating machine and the surrounding furniture, etc. The protruded pipe-shaped handle may not match the surrounding furniture.

In the door assembly 100 according to the embodiment shown in FIG. 3, the handle 22b′ is integrally formed with the side cap 20b′. There is no difference between the present embodiment and the previously-described embodiment, in consideration of the fact that the right side cap of the door assembly is integrally formed with the handle. However, the handle 22b′ of the door assembly 100 shown in FIG. 3 may be realized by providing the side cap 20b′ with a recessed portion 23b′, into which the user's hand can be inserted.

Similar to the embodiment shown in FIG. 2, in the present embodiment, both the side caps 20a and 20b′ are formed with insertion recesses 21a and 21b′, into which a stack of the plurality of door plates 10 can be inserted. However, note that the side cap 20b′ is formed with both the insertion recess 21b′ and the recessed portion 23b′ and thus, the insertion recess 21b′ must be designed in consideration of, for example, the position and size of the recessed portion 23b′.

In the present embodiment, more particularly, the handle 22b′ takes the form of a curved plate extending in a longitudinal direction of the side cap 20b′ to partition the recessed portion 23b′.

The recessed portion 23b′ and the handle 22b′ in the form of the curved plate are illustrated in detail in a partially enlarged cross sectional view included in FIG. 3.

The handle 22b′ is convexly curved toward the door plate 10 to define the recessed portion 23b′ along an inner periphery thereof.

The handle 22b′ and the recessed portion 23b′ are preferably designed to assure that the left and right side caps 20a and 20b′ have the same width.

The reason why the side cap 20b′ is formed with the recessed portion 23b′ is to prevent the handle 22b′ from protruding forward from a door. Accordingly, the curvature of the handle 22′ in the form of the curved plate and the shape of the recessed portion 23b′ must be determined to prevent the handle 22b′ from protruding outward, so as not to deteriorate the aesthetic exterior appearance of the door.

The side cap 20b′ formed with the handle 22b′ may have a constant transversal cross section throughout the longitudinal direction of the side cap 20b′. Of course, in an alternative embodiment, the recessed portion 23b′ may be formed only at a partial longitudinal region of the side cap 20b′.

The side cap 20b′ may be made of a metal material. In this case, even when the left and right caps 20a and 20b′ are made of, for example, aluminum, the handle 22b′ and the side cap 20b′ can be advantageously integrally formed with each other via extrusion molding. Specifically, the handle 22b′ can be obtained during extrusion molding of the side cap 20b′ without requiring an additional handle forming process and this is advantageous in view of production costs, etc.

Of course, in an alternative embodiment, the left and right caps 20a and 20b′ may be made of, for example, plastic.

The right side cap 20b′ shown in FIG. 3 has the recessed portion 23b′ and thus, the user's fingers can be inserted into the recessed portion 23b′ to open or close the door.

In this case, providing the right side cap 20b with the recessed portion 23b′ has the effect of positioning front surfaces of the left and right side caps 20a and 20b′ at the same plane. This configuration provides no unnecessary outward protrusion of the door assembly 100 and can satisfy the aesthetic demands of consumers.

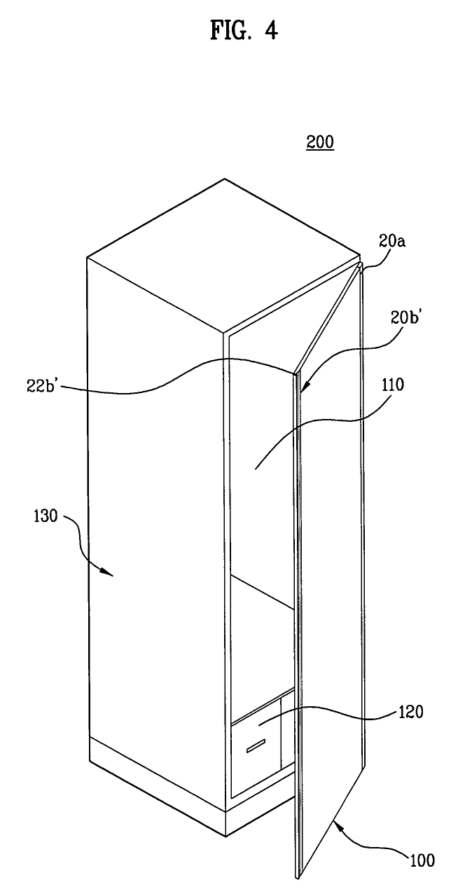

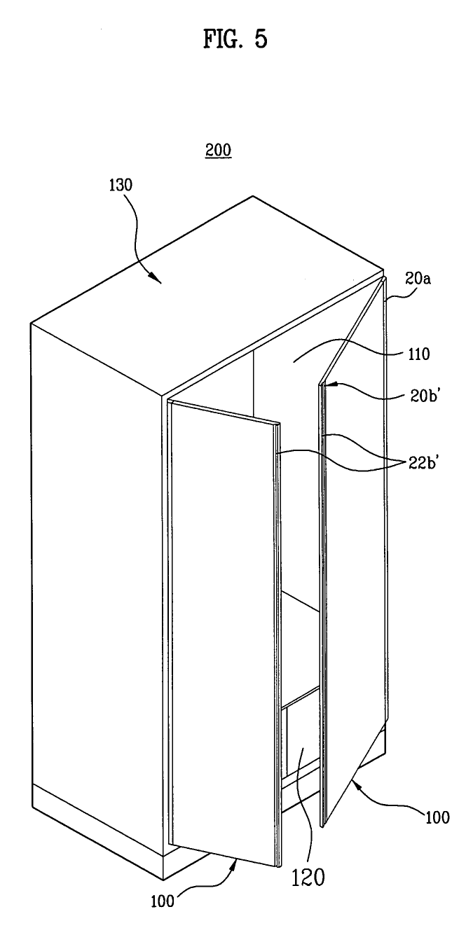

FIGS. 4 and 5 are perspective views illustrating different types of clothes treating machines according to the present invention. More particularly, FIG. 4 illustrates a single-door type clothes treating machine, and FIG. 5 illustrates a double-door type clothes treating machine.

The cabinet treating machine is an apparatus designed in such a manner that moisture (e.g. steam) or hot air (or dry air) is fed to clothes received in an accommodating space of the clothes treating machine, to remove unpleasant odors, wrinkles, moisture, or the like of the clothes.

In one example, if a person wears clothes at least one time, the clothes are saturated with unpleasant odors, wrinkles, moisture, or the like. The unpleasant odors, etc. of the clothes are unpleasant when the person tries to wear the clothes again. To remove the unpleasant odors, etc., the person must perform washing of the clothes even though the clothes are not dirty. This problematically reduces the lifespan of the clothes and increases maintenance costs of the clothes.

In another example, in the case of clothes that are completely washed and dried, they may often have wrinkles and thus, may be unsuitable to allow a person to directly wear the wrinkled clothes. That is, the person first must, for example, iron the wrinkled clothes.

To solve the above-described problems, use of the clothes treating machine to remove unpleasant odors, wrinkles, moisture, or the like of clothes can be contemplated.

To remove the unpleasant odors, wrinkles, moisture or the like of the clothes received in the clothes treating machine, moisture (e.g. steam) can be ejected to the clothes and also, hot wind or air can be used to dry the wet clothes containing the moisture.

Although simply exposing the clothes to hot wind or air is effective to remove the unpleasant odors, wrinkles, moisture or the like, using moisture (e.g. steam) can maximize the removal effect.

When moisture (e.g. steam) is ejected to the clothes received in the clothes treating machine, fine water particles are coupled with odors particles deeply saturated within fibers and then, the resulting water particles coupled with the odors particles are separated from the clothes during a drying operation. In this way, the unpleasant odors of the clothes can be removed.

Also, ejecting moisture (e.g. steam) to the clothes received in the clothes treating machine has the effect of removing wrinkles, etc. of the clothes. The moisture fed to the clothes can be removed during a drying operation. The drying operation is performed via simple air-blowing or feeding of hot or dry air.

With the above-described operation, unpleasant odors, wrinkles, moisture or the like of the clothes can be removed, allowing persons to wear clothes in a more pleasant condition.

The clothes treating machine generally takes the form of a cabinet internally defining an accommodating space 110 in which clothes are received. The accommodating space 110 is defined in an upper region of the cabinet, and a machine room 120 is located below the accommodating space 110. The machine room 120 receives a moisture supplying device (e.g. steam generator) to generate moisture to be fed into the accommodating space 110, an air supplying device to feed hot or dry air into the accommodating space 110, etc.

The accommodating space 110 and the machine room 120 may be arranged at upper and lower positions within the single cabinet 130. Clothes to be treated are received in the accommodating space 110, and if necessary, various shelves, hangers, or the like can be installed in the accommodating space 110.

The cabinet of the clothes treating machine can be provided with the door assembly 110. Specifically, the door assembly 110 is rotatably mounted to a cabinet door, to open or close the accommodating space 110.

Opening/closing of the door of the clothes treating machine according to the present invention is accomplished by the above-described handle 22b′ integrally formed with the right side cap 20b′.

As shown in FIGS. 4 and 5, the door assembly according to the present invention is applicable to both single-door type and double-door type electronic products. In the case of a double-door type electronic product, each door may be provided with the handle 22b′. Although FIGS. 4 and 5 illustrate the embodiments of the clothes treating machines provided with the door assembly according to the present invention, these embodiments are given only by way of example, and the door assembly according to the present invention can be applied to various kinds of electronic products.

As apparent from the above description, the present invention provides a door assembly in which a handle is integrally formed with any one of left and right side caps used to fixedly couple plural door plates to one another, resulting in a reduction in manufacturing costs.

Further, according to the present invention, as a result that the handle of the side cap takes the form of a recessed portion integrally defined in the side cap so as not to protrude outward from the side cap, the resulting door assembly can achieve an exterior appearance satisfying the aesthetic demands of consumers.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A door assembly comprising:
one or more door plates;
left and right side caps, into which both sides of the door plates are fixedly inserted, respectively; and
a handle integrally formed with one of the left and right side caps.

2. The door assembly according to claim 1, wherein the door plates include:
a front plate to be exposed forward; and
a rear plate defining a rear door surface.

3. The door assembly according to claim 2, further comprising an insulator provided between the front plate and the rear plate.

4. The door assembly according to claim 2, wherein:
the front plate is made of transparent glass or synthetic resins; and
an ornament is inserted between the front plate and the rear plate.

5. The door assembly according to claim 4, wherein the ornament is attached to or coated on the front plate.

6. The door assembly according to claim 1, wherein the handle is a circular rod member integrally formed with the side cap such that it is spaced apart from an outer surface of the side cap.

7. The door assembly according to claim 1, wherein the handle is a curved plate extending in a longitudinal direction of the side cap to define a recessed portion in the side cap.

8. The door assembly according to claim 7, wherein the side cap, formed with the handle, has a constant transversal cross section throughout the longitudinal direction of the side cap.

9. The door assembly according to claim 8, wherein the side cap is made of a metal material.

10. A clothes treating machine comprising:
a cabinet having an accommodating space in which clothes are received;
a machine room receiving at least one of a moisture supplying device to feed moisture into the accommodating space and an air supplying device to feed hot or dry air into the accommodating space, the machine room being defined in the cabinet and separated from the accommodating space; and
a door assembly to open or close the accommodating space, the door assembly including one or more door plates, left and right side caps, into which both sides of the door plates are fixedly inserted, respectively, and a handle integrally formed with one of the left and right side caps.

11. The clothes treating machine according to claim 10, wherein the door plates include a front plate to be exposed forward, a rear plate defining a rear door surface, and an insulator provided between the front plate and the rear plate.

12. The clothes treating machine according to claim 10, wherein the handle is a curved plate extending in a longitudinal direction of the side cap to define a recessed portion in the side cap.

13. The clothes treating machine according to claim 12, wherein the side cap, formed with the handle, has a constant transversal cross section throughout the longitudinal direction of the side cap.

14. The machine according to claim 13, wherein the side cap is made of a metal material.
